(19) United States
(12) Patent Application Publication
(10) Pub. No.: US 2016/0080346 A1
(43) Pub. Date: Mar. 17, 2016

(54) IDENTITY CERTIFICATION BADGE

(71) Applicant: TransUnion Rental Screening Solutions, Inc., Greenwood Village, CO (US)

(72) Inventors: Kurt Kuchta, Tinley Park, IL (US); Bala Krishnamurthy, Portland, OR (US); Jason Norton, Bonita, CA (US)

(21) Appl. No.: 14/855,926

(22) Filed: Sep. 16, 2015

Related U.S. Application Data
(60) Provisional application No. 62/051,559, filed on Sep. 17, 2014.

(51) Int. Cl. H04L 29/06; G06Q 20/40

(52) U.S. Cl. CPC H04L 63/08; G06Q 20/40

(57) ABSTRACT

Systems and methods for identity certification using an identity badge are disclosed herein. A method of providing an identity badge to a member is performed by an authentication system. The system receives a request for an identity badge, the request including some information about the member. The authentication system verifies the identity of the member and generates one or more reports about the member. The system then generates an identity badge for display on a third party user interface. A user viewing the member's profile can view the identity badge and may request access to the one or more reports via the identity badge. Upon receiving a request for access to the one or more reports, the system may respond by requesting more information or requesting authorization from the member.

### CROSS-REFERENCE TO RELATED APPLICATIONS

The present application claims benefit of priority to U.S. Provisional Patent Application No. 62/051,559, entitled “Identity Certification Badge” and filed on Sep. 17, 2014, which is specifically incorporated by reference herein for all that it discloses and teaches.

### FIELD

Implementations disclosed herein relate, in general, to information management technology and specifically to identity certification systems.

### SUMMARY

An identity certification system disclosed herein generates identity verification badges for members and allows other users to review such badges. In one implementation, the identity certification system receives a plurality of information related to a member at an authentication service, verifies an identity of the member based on the plurality of information, and if the member's identity is verified, generates an identity report, the identity badge notifying a level of identification for the member and associates a user selectable link to the identity badge, the user selectable link associating to one or more of a plurality of reports associated with the member. The identify badge may be and displayed at a user interface, such as a website, a mobile device application, etc. Furthermore, the system receives an input from a user selecting the user selectable link and allows the user to view one or more of the plurality of reports associated with the member.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates an example block diagram representing an identity certification system disclosed herein.

FIG. 2 illustrates an example flowchart illustrating operations of an identity certification system disclosed herein.

FIG. 3 illustrates an alternative example flowchart illustrating operations of an identity certification system disclosed herein.

FIG. 4 illustrates yet another alternative example flowchart illustrating operations of an identity certification system disclosed herein.

FIG. 5 illustrates an example identity badge.

FIG. 6 illustrates an example computing system that can be used to implement one or more parts of the identity certification system disclosed herein.

FIG. 7 illustrates an example mobile device that may be used to implement one or more parts of the identity certification system disclosed herein.

FIG. 8 illustrates an example list of potential target markets that may use the identity verification system disclosed herein.

FIG. 9 illustrates and example user interface provided by the identity certification system disclosed herein.

### DETAILED DESCRIPTION

The implementations disclosed herein provide an identity certification system that verifies an identity of a member and generates an identity badge to be displayed on a user interface, such as a partner website or mobile device application. The system further allows various users to select the identity badge to receive further information about the member.

For example, a member may request for an identity badge where the badge is to be displayed on a dating website. In such a case, the identity certification system collects various information from the member so as to verify the identity of the user. The system may also request access information to the member's social networks, to collect information about the member's social network status, friends, etc. The system may also collect credit information for the member, educational information, etc., so as to generate a more robust profile for the user. Based on the information collected from these various sources, the system generates an identity badge.

In one implementation, the identity badge generated by the system provides a number of different levels of verification. For example, such levels of verification may be associated with the type of the badge, the color of the badge, the size of the badge, etc. For example, a golden badge may specify a very high level of identity verification, whereas a bronze badge may specify an impartial or lower level of verification, etc.

Subsequently, the badge is displayed on a partner website, third party website, or mobile application. As an example, the member's badge is posted to a dating website where other users of the dating website can view the badge together with the profile of the member. In this case, the badge provides the other users comfort in viewing the member's profile with a verified or true identity and to establish further contact with the member. In one implementation, such identity badge may be associated with other detailed reports about the member via a link. For example, the identity badge may be posted on a dating website such that a user can click on the identity badge, touch on the identity badge, etc., to request additional information about the member.

In one implementation, upon receiving such input from the identity badge, the identity certification system directs the user to provide various options for getting additional information about the member. For example, if the identity certification system has generated a social report for the member where such report lists the number of friends for the member, political inclination of the member, etc., the system may offer the user an option to access one or more of such reports in response to getting additional fees from the user. For example, a member Adam may have requested the system to generate an identity badge and display it with his profile on a dating website. If a user Mary clicks on Adam's badge, the system may direct Mary to a page where she can pay fees to access more detailed reports about Adam.

In yet alternative implementation, the system allows the member to make the payment to allow the user to access the report. For example, if Adam's identity badge is posted on a dating website and if Mary asks to see the reports attached to Adam's identity badge, the system sends an email, text, etc., to Adam with information about the request and further information about Mary such as Mary's profile. The system may also offer Adam an option to make a payment to allow Mary to view the report. For example, Adam may find Mary's profile to be interesting enough that he may want to pay for Mary to review his profile. In such a case, the system presents the appropriate payment options to Adam to collect the payment information.

In yet alternative implementation, upon receiving the input from a user related to the identity badge, the system contacts the member to get an authorization to provide additional information about the member, such as the member's reports, to the user. In such a case, the system may also provide various information about the user providing the input via the identify badge to the member. For example, a member Adam may have requested the system to generate an identity badge and display it with his profile on a dating website. If a user Mary clicks on Adam's badge, the system may send Mary's profile to Adam together with an option to pay for the more detailed report about Adam to be sent to Mary. In such a case, if Adam agrees to such fees, Mary will be able to review the additional reports of Adam free of charge.

In yet alternative implementation, upon receiving an input via the identity badge, the system may require that the user providing such input authenticate or verify their identity. Thus, in the examples discussed above, when Mary selects the identity badge of Adam, the system may ask Mary to provide additional information about her before providing any additional information about Adam to Mary.

Yet alternatively, a partner website may be provided with an option where a user can request members of the partner website to get an identity verification badge. For example, a recruiter searching various resumes on an employment website can ask one of the candidate member to get an identity verification badge. In such a case, the system sends a message to the candidate member that a recruiter has requested an identity verification badge. In response, the candidate member provides information that is used by the system to generate an identity verification badge and the badge is sent to the recruiter and/or posted on the website.

Similar, implementations may be also provided for a partner website that are used to match investors with potential investment opportunities, a partner website used to match borrowers with lenders, partner website used to match real estate buyers with sellers, a partner website used to match tenants with landlords, etc.

Note that while the above examples are discussed in view of a dating website, similar identity badges may also be generated in view of employment, business verification, criminal record verification, credit verification, etc.

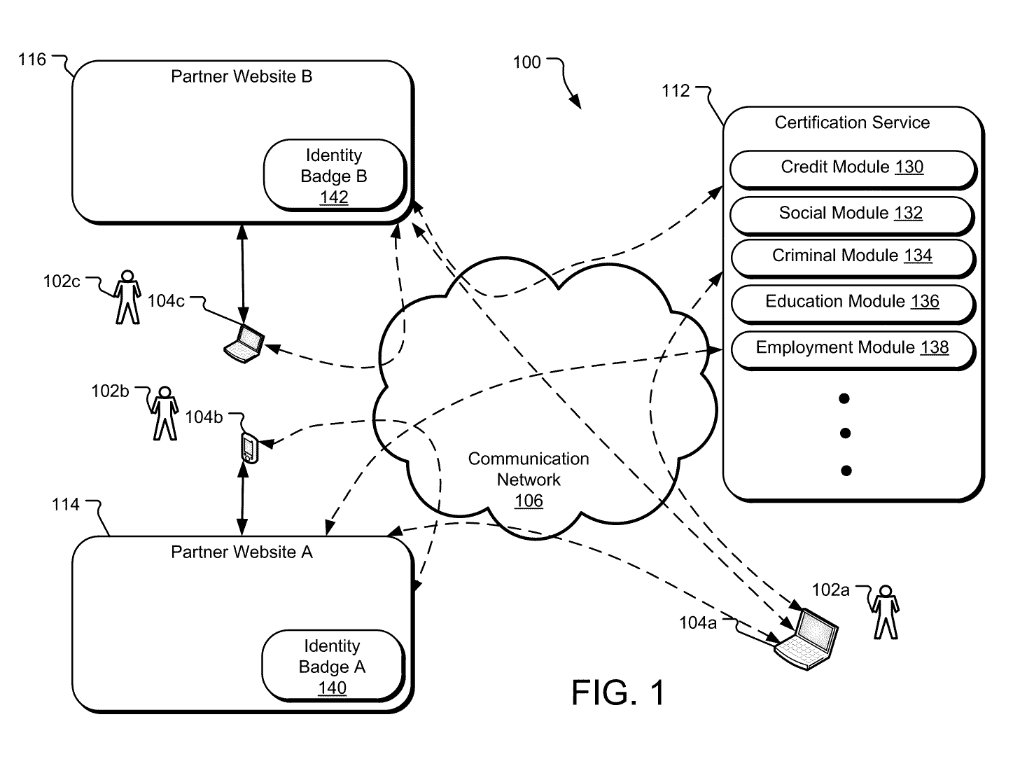

FIG. 1 illustrates an example block diagram 100 representing an identity certification system disclosed herein. The system includes a certification service 112 that may be communicatively connected to a communication network 106 to receive certification badge requests, display certification badges on partner websites (i.e., partner website A 114 and Partner Website B 116), and communicate and receive member information. The communication network 106 may be any of the commonly used networks such as the Internet. The term “network” may include local area networks (LANs), wide area networks (WANs), metro area networks, residential networks, corporate networks, inter-networks, the Internet, the World Wide Web, cable television systems, telephone systems, wireless telecommunications systems, fiber optic networks, token ring networks, Ethernet networks, ATM networks, frame relay networks, satellite communications systems, and the like. Such networks are well known in the art and consequently are not further described here.

Certification service 112 is configured to receive requests for identity badges. Certification service 112 consists of a number of modules (e.g., a Credit Module 130, a Social Module 132, a Criminal Module 134, an Education Module 136, an Employment module 138, etc.). Each module is configured to receive information via certification service 112, verify the information received, retrieve more information to associate with the member, and generate one or more reports about the member. The modules may generate reports regarding the respective topics about member. Certification service 112 also generates the identity badge that will be associated with the member. Certification service 112 may retrieve reports generated by the one or more modules and associate those reports with the generated badge. For example credit module 130 is configured to receive information regarding the identity of a member (e.g., social security number), and then retrieve credit information and generate a credit report about that member. Certification Service 112 may then associate the credit report with that member via the identity badge. The other modules work in the same or in similar ways. Social Module 132 may request social media profile information from the member, then scan the member's social media profiles and generate a social media report. The report will then be associated with the member via the identity badge as described above.

Member 102a communicates with Partner Website A 114 and Partner Website B 116 via a computer 104a and communication network 106. Computer 104a may be a desktop computer, laptop computer, mobile device, etc. Partner Website A 114 and Partner Website B may be a form of a job seeking website, dating website, social website, or any type of website that may require a user account. In this example illustration, the profiles are posted on and accessed via websites, but the profiles may be on another user interface such as a mobile application. Member 102a has a profile on Partner Website A 114 and Partner Website B 116, and member 102a has requested an identity certification badge or one or both of the websites have required member 102a to get a identity badge. Alternatively, a user (e.g., user 102b and 102c) of one of the websites may have requested that the member get an identity badge. Member 102a communicates with certification service 112 and provides all the necessary information required to create a badge. Certification service 112 then acts as described above. Certification service will then allow member 102a to display the identity badge on the partner website (e.g., identity badge 140 displayed on partner website A 114 and identity badge B 142 displayed on partner website B 116). Identity badge A 140 and identity badge B 142 may be the same displayed identity badge or different identity badges depending on the websites on which they are displayed. For instance, if partner Website A 114 is a job seeking website, then the identity badge A 140 might display that member 102a's employment history and criminal history have been verified. On the other hand, if partner website B 116 is a dating website, then identity badge B 142 might display that the member 102a's social profile and criminal history have been verified. Note that while in the implementation disclosed in FIG. 1 above, the identity badges 140, 142 are displayed on the partner websites 114, 116, in alternative implementations, the identity badges 140, 142 may be made available via applications such as mobile apps, etc.

Users (e.g., user 102c and user 102b) visiting the partner websites 114 and 116 (or applications) may be able to view the member 102a's profiles that display the respective identity badges 140 and 142. Users 102b and 102c may view the badge on a computer or mobile phone using a web browser or application. Users 102b and 102c may be a potential employer on a job seeking website, a potential partner on a dating website, a potential landlord seeking tenants, etc. For example, if user 102b is a landlord, he may see that member 102a's badge may show that he has a good credit report and a good criminal history. This may lead user 102b to accept member 102a's application to rent a property from user 102a. However, user 102b may wish to see more information about member 102a. User 102b can click the badge to request more information. Certification service 112 receives the request for more information and may respond in any of, but not limited to, the following ways: (a) provide the information to user 102b, (b) seek authorization from member 102a by notifying member 102a that a request has been made, (c) seek payment from user 102b in exchange for information, and (d) seek information from user 102b to give to member 102a in exchange for member 102a's information. The information provided may be in the form of the reports that one or more of the modules have generated. Further, the user 102b or 102c may request additional information that has not been provided by the member or generated by one of the modules. In this case, the certification service 112 will receive the request and notify member that a user has requested more information. The member may respond by giving the information. All the described interaction/communication will take place across communication network 106 and will be handled by certification service 112, the modules, and the partner websites (e.g., partner website A 114, and partner website B 116).

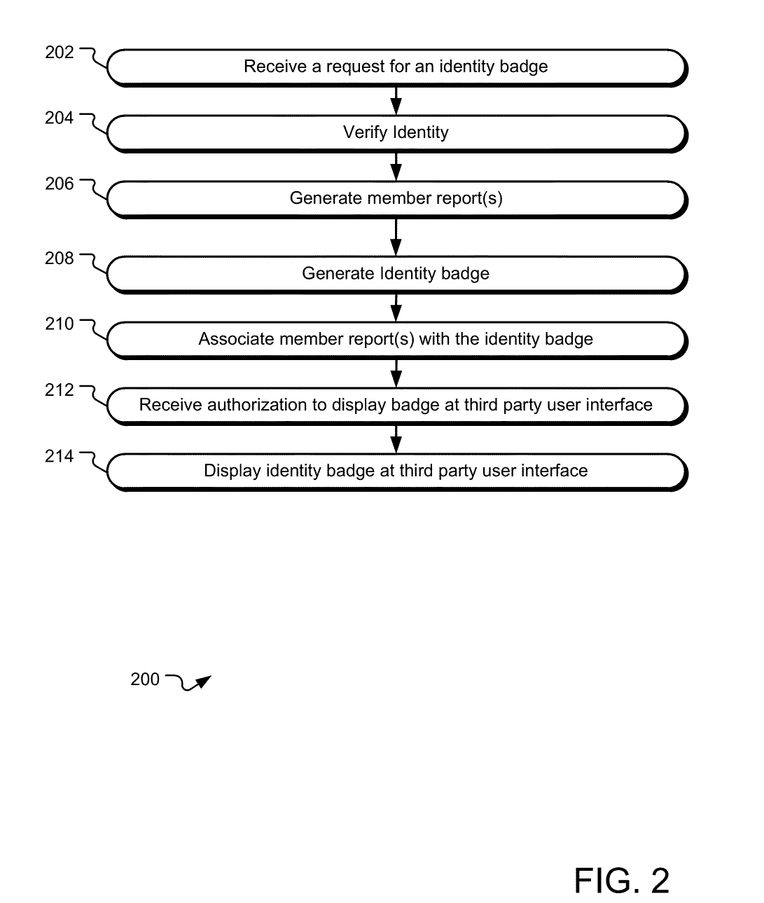

FIG. 2 illustrates an example flowchart 200 illustrating operations of an identity certification system disclosed herein. A receiving operation 202 receives a request for an identity badge from a member. The request will include some amount of information about the member. The member may apply for the badge through an application or website interface by filling out a form with information about the member. The information may be retrieved from the member's social media accounts or other website account. The information may include employment data, credit and financial data, relationship and family history, social media history, etc. Receiving operation 202 may be in response to a member signing up for an account or profile with a third party website or application. The third party website or application may then request that the member sign up for an identity badge. In response to receiving a request, the member may be required to provide some type of payment before the system will provide an identity badge. The system may present to the member a plurality of payment options (e.g., credit cards, PayPal®, etc.). Once payment is received then the steps may continue.

Verifying operation 204 verifies the identity of the member using the amount of information received or retrieved. A verification service uses the information received with the request and verifies the identity. If the identity is verified, the service may email or otherwise notify the member that the identity has been verified. In some instances, the verification service may only acquire a partial verification of the member. In this case, the verification service may notify the member that there has been only a partial verification and may request more information. The member may respond with more information or use the partial verification. If a member is not verified, then the member will be denied access to an identity badge.

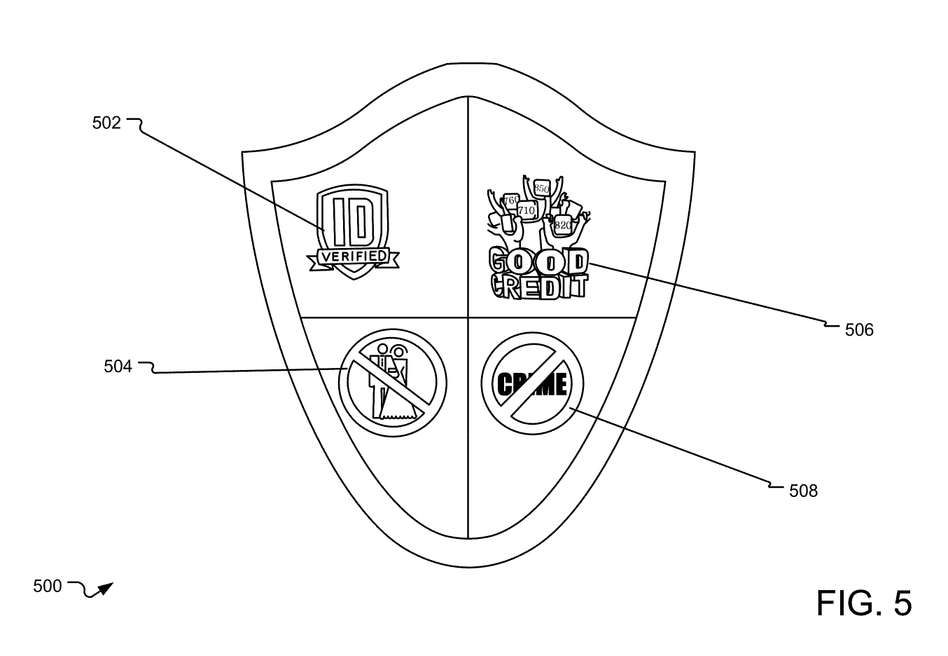

Generating operation 206 generates one or more reports associated with the member. The reports are based on the information received with the request and other information that the service may find. The reports may be a report regarding the employment history about the member, a credit or financial history of the member, a social media report of the member, a relationship history about the member, etc. A second generating operation 208 generates an identity badge. Generating operation 208 generates the identity badge based on the one or more reports associated with the member and/or the level of verification. For instance, if a credit report has been generated and the report states that the member has good credit, one portion of the identity badge may signal that the member has a good credit standing. On the other hand, if the member has bad credit, then the badge may signal that the member has a bad credit standing. Further, if there has been only a partial verification of the member, the badge may signal the partial verification. For example, if the member has only his name verified and not his credit or employment history, then the badge may signal that the identity has been verified but nothing else. The signaling may be accomplished by using a combination of words, symbols, colors, etc. Further, different portions of the badge may signal different reports or levels of verification. An exemplary identity badge is illustrated in FIG. 5.

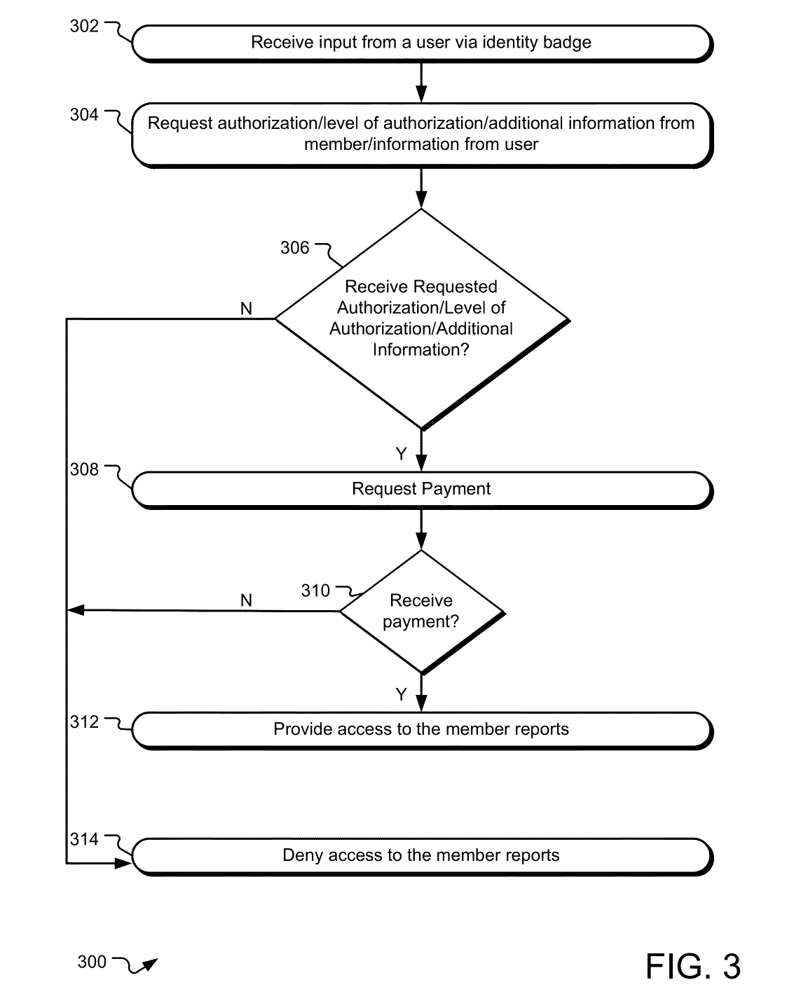

An associating operation 210 associates the one or more reports to the identity badge via a user selectable link. The reports are linked to the identity badge, so that once the badge is displayed a user may click on the badge to view or request to view the generated reports. Exemplary operations for a response to user input are illustrated and described with respect to FIG. 3.

A receiving operation 212 receives authorization to display the identity badge on a third party application or website interface. The receiving operation 212 may be preceded by a request sent to the member requesting authorization to post the badge on the partner website or application interface. Receiving operation 212 may also be accomplished by the member requesting that the badge be posted on the third party website or application interface. Authorization from the third party website may also be required.

A displaying operation 214 displays the member's identity badge on the third party application or website interface. The displaying operation 214 may display the badge in a location corresponding with the member's profile on the third party interface, signaling to viewers of the profile the generated reports and/or levels of verification. The displayed badge may vary depending on the type of third party application or website. For example, if the badge is being displayed a job seeking website, then the badge may display that the employment history is verified but will not signal the member's credit report because such information may be irrelevant to employers.

FIG. 3 illustrates an alternative example flowchart illustrating operations of an identity certification system disclosed herein. Specifically, FIG. 3 discloses operations when a user requests member reports that have been associated with a member by selecting a user selectable link associated with the identity badge. Receiving operation 302 receives an input from a user via an identity badge. The identity badge has been associated with a member and the badge has been posted next to a user profile on a website or application. When a user selects the identity badge, the user may be provided with the option to select a report they wish to request. I

In response to the receiving input via the identity badge, the system may respond in a number of ways via requesting operation 304. For example, in one implementation, requesting operation 304 may request authorization from the member to allow the user view the one or more reports. In a same or different implementation requesting operation 304 may request a level of authorization from the member, wherein the level of authorization delineates what reports/information that the user may access. In another same or different implementation requesting operation 304 may request additional information from the member, wherein the user requests the additional information about the member. To explain further, a user viewing the member's profile with only a verified identity may wish to see a more robust profile for the member (e.g., a credit report). The system may respond by sending a message to the member to provide more information so that the system can generate the report and provide it to the user. In another similar or different implementation, requesting operation 304 may request information from the user. In this example implementation, the user may be required to sign up for an identity badge in exchange for accessing the information about the member. In another example implementation requesting operation 304 may request that the user pay to attain access to the member reports.

Receiving operation 306 receives the requested information or authorization from the member or user. If the requested authorization or information is not received from the user or member, then denying operation 314 denies the user access to the member reports. If the requested authorization or information is received from the member, a second requesting operation 308 may request a payment from the user. Second requesting operation 308 is optional. The payment requested depends on the type of information or level of authorization sought from the member or user. For example, if the user is requesting to see all reports associated with the member then the amount of payment requested may be more than if the user is only request a criminal report. A second receiving operation 310 receives the requested payment. If the payment is not received by receiving operation 310, then denying operation 314 denies the user access to the member reports. If the payment is received by receiving operation 310, then providing operation 312 provides the user access to the requested member reports. The access may be provided by sending the user an email with the reports, by presenting the reports through the website or user interface, or by providing an access key to the user may access the reports using the key.

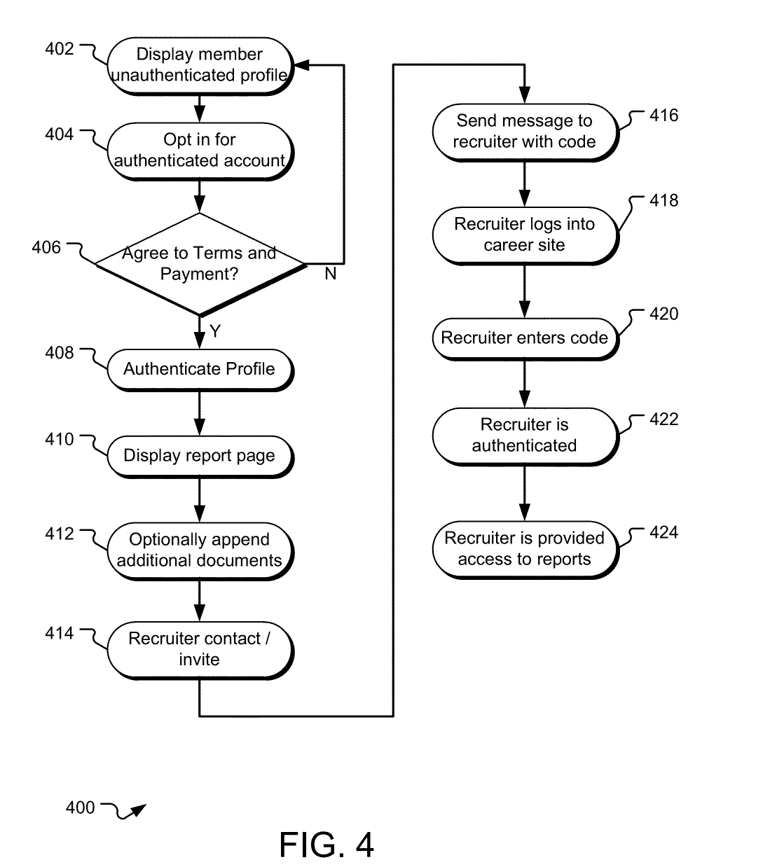

FIG. 4 illustrates yet another alternative example flowchart 400 illustrating operations of an identity certification system disclosed herein. Specifically, FIG. 4 discloses operations for an identity certification system implemented in view of potential job seekers working with recruiters. Display operation 402 displays a member/jobseeker profile at a career website. The member has either logged in or navigated to his or her profile page. At opting operation 404, the member can opt in to an authenticated account by clicking a link on the profile page. By opting in, the member is taken to an agreement/paying page where determining operation 406 determines whether the member agrees to the terms and agrees to pay for an authenticated account. If the member does not agree to the terms or does not pay, then the member is taken back to display operation 402 where the unauthenticated profile is displayed. If the member does agree to the terms and agrees to pay, then an authenticating step 408 authenticates the profile. During authenticating step 402, the service may pull all of the data from the existing unauthenticated profile and it may ask for additional information. The data is sent to an authenticating service where member reports are generated. A second display operation 410 displays a report page. The reports generated by the authentication service are displayed to the member. Next the member has an option do appending additional documents (e.g., a resume, cover letter) to the profile at an optional appending operation 412.

At recruiter contacting or inviting operation 414 a job recruiter either is invited to view the member profile or the recruiter finds the member profile via a search engine, the career site, or any other means. If the member invites the recruiter, the member can choose to send the recruiter a message with an access code. If the recruiter finds the profile through other means, the recruiter can request an access code, and the member can respond by authorizing an access code. At a logging in operation 418, a recruiter logs into the career site to view the member profile. At an entering operation 420, the recruiter enters the access code. At a second authenticating operation 422 the recruiter is authenticated by matching the access code with the recruiter profile used to log in. At a providing operation 424, the recruiter is provided access to the member reports. The recruiter may be limited in access for a period of time or for a number of accesses.

FIG. 5 illustrates an example identity badge 500. Specifically, the example badge 500 provides identity verification 502, marital status verification 504, credit level verification 506, and criminal status verification 508. It should be noted that badges could come in a variety of shapes, sizes, colors, and configurations. Further the verification symbols (e.g., symbols 502, 504, 506, and 508) are unlimited in shapes, sizes, colors, and configurations. Identity verification 502 is an example symbol representing to a viewer of the member profile that the member's identity is verified. Credit level verification 506 signifies to a viewer of the member profile that the member has a good credit rating. Marital status verification 504 signifies to a viewer of the member profile that the member is not legally married. Criminal status verification 507 signifies to a viewer of the member profile that the member has no criminal record. Other verification symbols are contemplated. In one implementation, the identity badge generated by the system provides a number of different levels of verification. For example, such levels of verification may be associated with the type of the badge, the color of the badge, the size of the badge, etc. For example, a golden badge may specify a very high level of identity verification, whereas a bronze badge may specify an impartial or lower level of verification, etc.

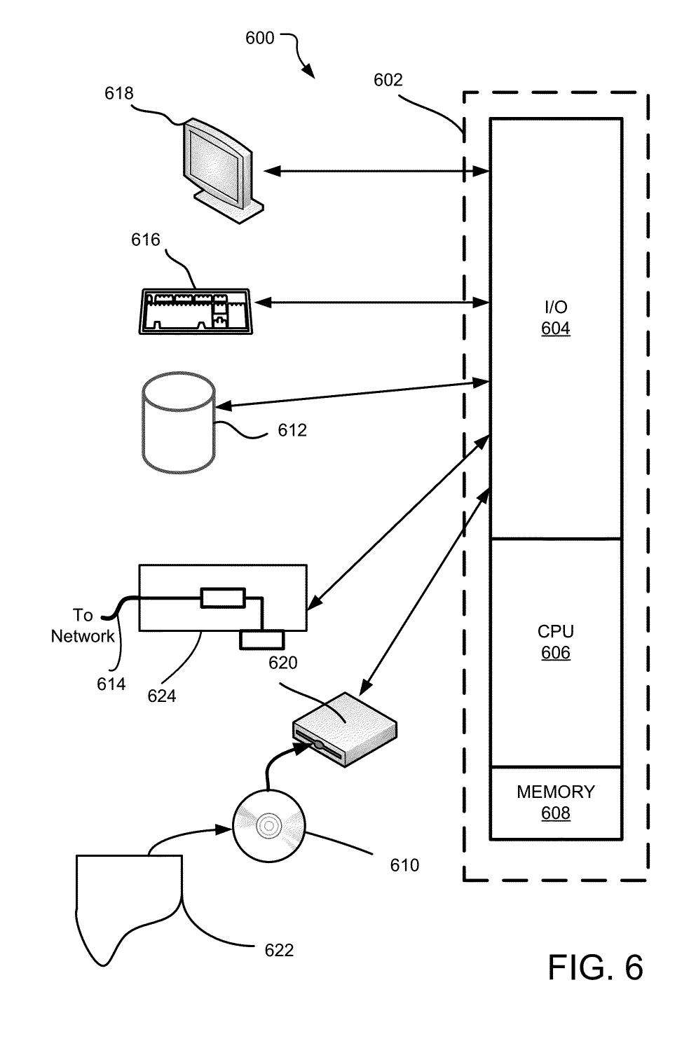

FIG. 6 illustrates an example computing system that can be used to implement one or more components of the identity verification system method and system described herein. A general-purpose computer system 600 is capable of executing a computer program product to execute a computer process. Data and program files may be input to the computer system 600, which reads the files and executes the programs therein. Some of the elements of a general-purpose computer system 600 are shown in FIG. 6, wherein a processor 602 is shown having an input/output (I/O) section 604, a Central Processing Unit (CPU) 606, and a memory section 608. There may be one or more processors 602, such that the processor 602 of the computer system 600 comprises a single central-processing unit 606, or a plurality of processing units, commonly referred to as a parallel processing environment. The computer system 600 may be a conventional computer, a distributed computer, or any other type of computer such as one or more external computers made available via a cloud computing architecture. The described technology is optionally implemented in software devices loaded in memory section 608, stored on a configured DVD/CD-ROM 610 or storage unit 612, and/or communicated via a wired or wireless network link 614 on a carrier signal, thereby transforming the computer system 600 in FIG. 6 to a special purpose machine for implementing the described operations.

The I/O section 604 is connected to one or more user-interface devices (e.g., a keyboard 616 and a display unit 618), a disk storage unit 612, and a disk drive unit 620. Generally, in contemporary systems, the disk drive unit 620 is a DVD/CD-ROM drive unit capable of reading the DVD/CD-ROM medium 610, which typically contains programs and data 622. Computer program products containing mechanisms to effectuate the systems and methods in accordance with the described technology may reside in the memory section 608, on a disk storage unit 612, or on the DVD/CD-ROM medium 610 of such a system 600, or external storage devices made available via a cloud computing architecture with such computer program products including one or more database management products, web server products, application server products and/or other additional software components. Alternatively, a disk drive unit 620 may be replaced or supplemented by a floppy drive unit, a tape drive unit, or other storage medium drive unit. The network adapter 624 is capable of connecting the computer system to a network via the network link 614, through which the computer system can receive instructions and data embodied in a carrier wave. Examples of such systems include Intel and PowerPC systems offered by Apple Computer, Inc., personal computers offered by Dell Corporation and by other manufacturers of Intel-compatible personal computers, AMD-based computing systems and other systems running a Windows-based, UNIX-based, or other operating system. It should be understood that computing systems may also embody devices such as Personal Digital Assistants (PDAs), mobile phones, smart-phones, gaming consoles, set top boxes, tablets or slates (e.g., iPads), etc.

When used in a LAN-networking environment, the computer system 600 is connected (by wired connection or wirelessly) to a local network through the network interface or adapter 624, which is one type of communications device. When used in a WAN-networking environment, the computer system 600 typically includes a modem, a network adapter, or any other type of communications device for establishing communications over the wide area network. In a networked environment, program modules depicted relative to the computer system 600 or portions thereof, may be stored in a remote memory storage device. It is appreciated that the network connections shown are exemplary and other means of and communications devices for establishing a communications link between the computers may be used.

Further, the plurality of internal and external databases, data stores, source database, and/or data cache on the cloud server are stored as memory section 608 or other storage systems, such as disk storage unit 612 or DVD/CD-ROM medium 610 and/or other external storage device made available and accessed via a cloud computing architecture. Still further, some or all of the operations for the identity certification system disclosed herein may be performed by the processor 602. In addition, one or more functionalities of the system disclosed herein may be generated by the processor 602 and a user may interact with these GUIs using one or more user-interface devices (e.g., a keyboard 616 and a display unit 618) with some of the data in use directly coming from third party websites and other online sources and data stores via methods including but not limited to web services calls and interfaces without explicit user input.

The memory section 608 may include tangible computer-readable storage media, which includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store data. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal.

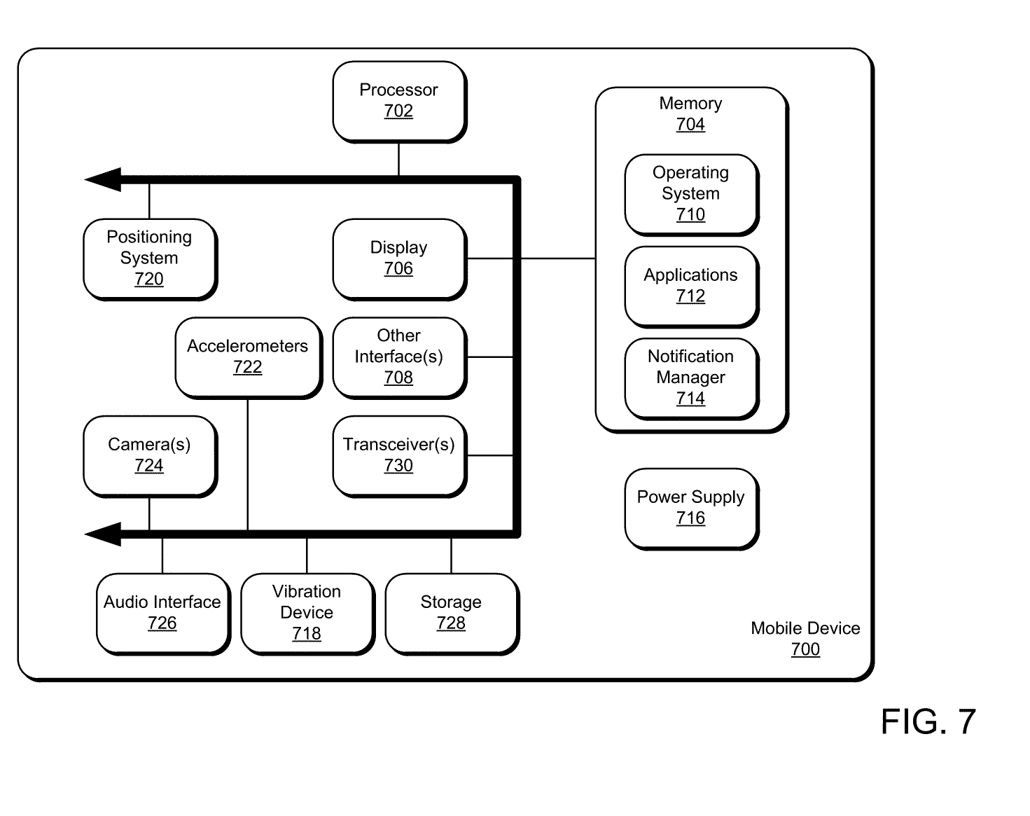

FIG. 7 illustrates another example system (labeled as a mobile device 700) that may be useful in implementing the described technology. The mobile device 700 includes a processor 702, a memory 704, a display 706 (e.g., a touchscreen display), and other interfaces 708 (e.g., a keyboard). The memory 704 generally includes both volatile memory (e.g., RAM) and non-volatile memory (e.g., flash memory). An operating system 710, such as the Microsoft Windows® Phone 7 operating system, resides in the memory 704 and is executed by the processor 702, although it should be understood that other operating systems may be employed.

One or more application programs 712 are loaded in the memory 704 and executed on the operating system 710 by the processor 702. Examples of applications 712 include without limitation email programs, scheduling programs, personal information managers, Internet browsing programs, multimedia player applications, etc. A notification manager 714 is also loaded in the memory 704 and is executed by the processor 702 to present notifications to the user. For example, when a promotion is triggered and presented to the shopper, the notification manager 714 can cause the mobile device 700 to beep or vibrate (via the vibration device 718) and display the promotion on the display 706.

The mobile device 700 includes a power supply 716, which is powered by one or more batteries or other power sources and which provides power to other components of the mobile device 700. The power supply 716 may also be connected to an external power source that overrides or recharges the built-in batteries or other power sources.

The mobile device 700 includes one or more communication transceivers 730 to provide network connectivity (e.g., mobile phone network, Wi-Fi®, BlueTooth®, etc.). The mobile device 700 also includes various other components, such as a positioning system 720 (e.g., a global positioning satellite transceiver), one or more accelerometers 722, one or more cameras 724, an audio interface 726 (e.g., a microphone, an audio amplifier and speaker and/or audio jack), and additional storage 728. Other configurations may also be employed.

In an example implementation, a web page optimization system, and other modules and services may be embodied by instructions stored in memory 704 and/or storage devices 728 and processed by the processing unit 702. The master pages, the layouts, and other data may be stored in memory 704 and/or storage devices 728 as persistent datastores.

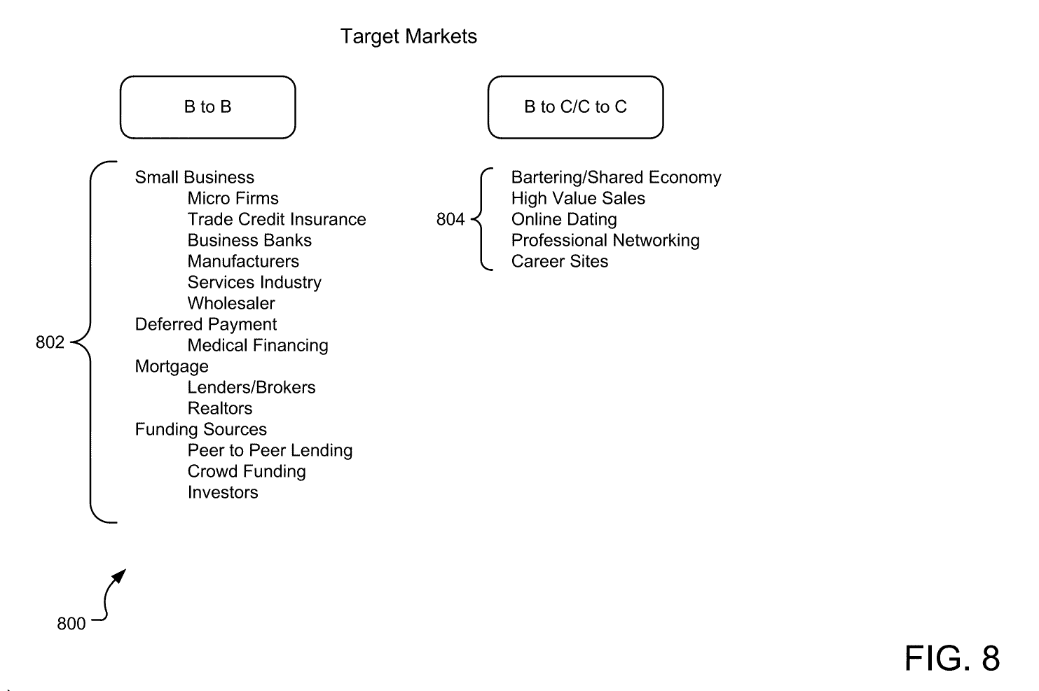

FIG. 8 illustrates an example list 800 of potential target markets that may use the identity verification system disclosed herein. It should be noted that this is just an example list, and other uses have been contemplated. Business to business list 802 lists some example business-to-business markets that may use the identity verification system disclosed herein. Business to consumer/consumer to consumer list 804 lists some example business to consumer or consumer-to-consumer markets that may use the identity verification system disclosed herein. Referring now to list 802 for example, a wholesaler may wish to require a retailer to use the identify verification system. The wholesaler may be able to see that a retailer is verified and has a good credit history, and therefore the wholesaler may wish to do business with a retailer. Another example use of the identity verification system from business to business list 802 is in the context of crowd funding. An investor may want to see that an identity of an entity seeking funding is verified before investing money. The investor may want to know that the persons controlling n the entity are trustworthy and have a good credit history.

Another example use of the identity verification service disclosed herein comes from Business to consumer/consumer to consumer list 804. In todays online bartering and sharing economy world, the identity verification system disclosed herein can be very useful. For example, person bidding on an item on an online auction website (e.g., Ebay®) may want to know that the seller's identity has been verified and that the seller has a good history of selling. Instead of going to a seller review screen to check user reviews of the seller, the buyer can just see a displayed badge that shows that the seller is trusted. Another example use in the bartering/shared economy is ride sharing. A rider or a driver for a ride sharing platform (e.g., Uber®, Lyft®) may want to know that the other's identity is verified and that they have a good history in using or providing the service. A badge displayed in the user interface of the mobile application can quickly verify that the person has a good history of using or providing the service.

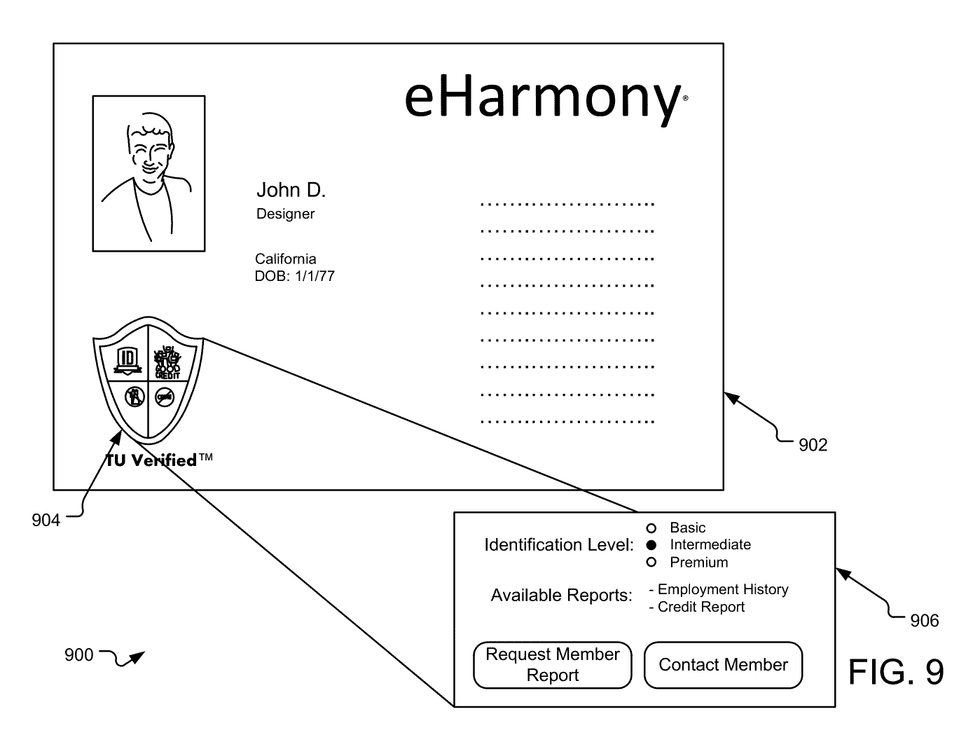

FIG. 9 illustrates and example user interface 900 provided by the identity certification system disclosed herein. Specifically, FIG. 9 discloses a user interface 900 provided by the identity certification system implemented in view of the online dating website, eHarmony®. Profile 902 displays a member's profile including the member's name, job title, domicile, and date of birth. Furthermore, profile 902 displays the member's identity badge 904. Identity badge 904 signifies to a viewer of the member's profile 900 that the member's identity has been verified. Furthermore, identity badge 904 may also signify that the member has no criminal record, the member's marital status is single, the member has good credit, etc. In this example implementation, identity badge 904 also serves as a clickable link. If a viewer of the profile clicks the link then user interface 906 may be displayed. In this example implementation, user interface 906 displays the level of identification of the member and shows what reports about the member may be available. User interface 906 may also provide clickable buttons that may allow the viewer to contact the member or request one or more member reports. Other clickable options are contemplated.

Embodiments of the present technology are disclosed herein in the context of an identity certification system. In the above description, for the purposes of explanation, numerous specific details are set forth in order to provide a thorough understanding of the present invention. It will be apparent, however, to one skilled in the art that the present invention may be practiced without some of these specific details. For example, while various features are ascribed to particular embodiments, it should be appreciated that the features described with respect to one embodiment may be incorporated with other embodiments as well. By the same token, however, no single feature or features of any described embodiment should be considered essential to the invention, as other embodiments of the invention may omit such features.

In the interest of clarity, not all of the routine functions of the implementations described herein are shown and described. It will, of course, be appreciated that in the development of any such actual implementation, numerous implementation-specific decisions must be made in order to achieve the developer's specific goals, such as compliance with application—and business-related constraints, and that those specific goals will vary from one implementation to another and from one developer to another.

According to one embodiment of the present invention, the components, process steps, and/or data structures disclosed herein may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present invention, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, Calif., Windows Vista™, Windows NT®, Windows XP PRO, and Windows® 2000, available from Microsoft Corporation of Redmond, Wash., Apple OS X-based systems, available from Apple Inc. of Cupertino, Calif., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general purpose machines; and. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present technology, the term “data store” describes a hardware and/or software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, SQL databases, audit trails and logs, program memory, cache and buffers, and the like.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understand that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method, comprising:
Receiving, using a computing device, a plurality of information related to a member at an authentication service;
verifying an identity of the member based on the plurality of information;
if the member's identity is verified:
generating an identity badge, the identity badge notifying a level of identification for the member;
associating a user selectable link to the identity badge, the user selectable link associating to one or more of a plurality of reports associated with the member, and
displaying the identity badge at a user interface on a computer output device;
receiving an input from a user selecting the user selectable link;
allowing the user to view one or more of the plurality of reports associated with the member.

2. The method of claim 1, wherein displaying the identity badge further comprises:
providing the identity report and the level of identification to the member; and
displaying the identity badge after receiving an authorization from the member.

3. The method of claim 1, wherein allowing the user to view one or more of the plurality of reports associated with the member further comprises:
providing a plurality of payment options to the user; and
receiving a payment from the user.

4. The method of claim 1, wherein the user interface is at least one of a website and a smartphone application interface.

5. The method of claim 1, wherein the plurality of reports associated with the member comprises at least one of a credit report of the user, a criminal report of the user, an educational report of the user, and a social network report of the user.

6. A method, comprising:
receiving a request for an identity badge from a member, the request including a plurality of information about the member;
verifying an identity of the member using the plurality of information about the member;
if the member's identity is verified:
generating one or more reports associated with the member;
generating an identity badge based on the one or more reports and a level of authorization;
associating the one or more reports to the identity badge via a user selectable link.
receiving an authorization from the member to display the identity badge at a third party website or application; and
displaying the identity badge at the third party website or application.

7. The method of claim 6 further comprising:
receiving an input from a user selecting the user selectable link;
requesting an authorization from the member to provide the one or more reports to the user; and
in response to receiving the authorization, providing the one or more reports to the user.

8. The method of claim 7, wherein requesting the authorization further comprises requesting a level of authorization and wherein providing the one or more reports to the user further comprises providing the one or more of the reports based on the level of authorization received from the member.

9. The method of claim 7, wherein providing the one or more reports to the user further comprises:
providing a plurality of payment options to the user, each of the payment options associated with a level of reports provided to the user;
receiving a payment from the user.

10. The method of claim 6 further comprising:
receiving an input from a user selecting the user selectable link;
requesting a plurality of information about the user from the user;
in response to receiving the plurality of information about the user, providing the one or more reports to the user; and
providing the plurality of information about the user to the member.

11. The method of claim 6, further comprising:
updating the one or more reports associated with the member if the plurality of information about the member changes; and
notifying a user that the one or more reports associated with the member has been updated.

12. The method of claim 6, wherein the one or more reports associated with the member comprises at least one of a credit report of the member, a criminal record of the member, an educational report of the member, an employment record of the member, and a social network report of the member.

13. The method of claim 6 further comprising:
receiving an input from a user selecting the user selectable link;
providing the one or more reports to the user, based on a pre-authorization by the member.

14. A method, comprising:
receiving a request for an identity badge from a member, the request including a plurality of information about the member;
verifying an identity of the member using the plurality of information about the member;
if the member's identity is verified:
generating one or more reports associated with the member;
assigning a level of verification to the member based on the one or more reports;
generating an identity badge based the level of verification;
receiving an authorization from the member to display the identity badge at a third party website or application;
displaying the identity badge at the third party website or application;
associating the one or more reports to the displayed badge via a user selectable link;
receiving an input from a user selecting the user selectable link; and
allowing the user to view the one or more reports associated with the member.

15. The method of claim 14, wherein receiving an input from a user selecting the user selectable link further comprises:
receiving a request from the user for additional information about the member;
notifying the member that the user has requested additional information;
receiving the additional information from the member;
generating one or more additional reports associated with the member; and
associating the one or more additional reports to the identity badge.

16. The method of claim 14, wherein the one or more reports associated with the member comprises at least one of a credit report of the member, a criminal record of the member, an educational report of the member, an employment record of the member, and a social network report of the member.
